(19) United States
(12) Patent Application Publication
(10) Pub. No.: US 2022/0374420 A1
(43) Pub. Date: Nov. 24, 2022

(54) SYSTEM AND METHOD FOR SUPPORTING AD HOC MULTILINGUAL NATURAL LANGUAGE DATABASE QUESTIONS WHICH ARE TRANSFORMED IN REALTIME TO DATABASE QUERIES USING A SUITE OF CASCADING, DEEP NEURAL NETWORKS WHICH ARE INITIALLY AND CONTINUOUSLY TRAINED THROUGH SCHEMA INFORMATION AND QUESTION-QUERY EXAMPLES

(71) Applicants: Peter Relan, Atherton, CA (US); Amol Kelkar, Redmond, WA (US); Nachiketa Rajpurohit, San Mateo, CA (US); Utkarsh Mittal, Foster City, CA (US); Hung Tran, Foster City, CA (US)

(72) Inventors: Peter Relan, Atherton, CA (US); Amol Kelkar, Redmond, WA (US); Nachiketa Rajpurohit, San Mateo, CA (US); Utkarsh Mittal, Foster City, CA (US); Hung Tran, Foster City, CA (US)

(21) Appl. No.: 17/328,552

(22) Filed: May 24, 2021

(51) Int. Cl. G06F 16/242; G06N 3/04; G06F 40/279; G06F 40/117; G06F 40/30

(52) U.S. Cl. CPC G06F 16/243; G06N 3/0454; G06N 3/0436; G06F 40/279; G06F 40/117; G06F 40/30

(57) ABSTRACT

The present invention relates generally to the field of providing a computer-implemented system and method that supports ad hoc multilingual Natural Language database questions that are transformed in realtime to Database queries using a suite of cascading Deep Neural Networks which are initially and continuously trained through schema information and question-query examples.

### CROSS-REFERENCE TO RELATED APPLICATIONS

This application claims the benefit of U.S. Provisional Application No. 63/032,537, filed on May 30, 2020, the content of which is incorporated herein by reference.

### FIELD OF THE INVENTION

The present invention relates generally to the field of providing a computer-implemented system and method that supports ad hoc multilingual Natural Language database questions that are transformed in realtime to Database queries using a suite of cascading Deep Neural Networks which are initially and continuously trained through schema information and question-query examples.

The present invention allows users to ask ad hoc Natural Language questions of Databases and Data Warehouses without the need to analyze or understand the underlying database schema or to compose valid SQL queries. The system and method of the present invention takes the users' ad hoc Natural Language questions and turns them into valid SQL queries using a suite of cascading Deep Neural Networks that are initially and continuously trained through schema information and question-query examples.

### BACKGROUND

Natural Language Processing or NLP using Deep Neural Networks has become an active field of research and commercial work in recent years. Many types of applications of NLP are being developed including sentiment analysis of social media posts (negative, positive, neutral), summarization of large bodies of text, extraction of named entities from text (getting names and addresses out of a mortgage contract) etc.

Databases have been around for decades, and the most popular ones include Relational Databases which store structure data in tables, and have a query language such as SQL, as well as NoSQL databases which store semi structured or unstructured data such as text, images etc and have their own query language.

The field that combines NLP and Database Queries is a specialized field and the core problem that is targeted here is being able to take a natural language question from a user who does not know the target database query language (in one instance SQL), and have a trained AI model or models that can translate the natural language question to a database query. Hence making it possible for naive users to extract from or put into databases information, using natural language.

In the past specific approaches to solving this problem have included: (A) simple, highly constrained questions from end users that can be translated to database queries with high accuracy by an AI model. (B) somewhat constrained questions from end users that can be translated to database queries with high accuracy but involving the user to some extent in confirming the intent of the query by an AI model. (C) very general, linguistically unconstrained questions that can be translated to database queries with not very high accuracy.

No past or existing system has combined all three approaches in a stepwise cascading combination of AI models, each trained differently against the same target database schema, to deliver a 100% accurate output database query, with differing degrees of human involvement depending on which step in the cascade the output is produced. The present invention does this, and thus uses the combination in the most optimal way, utilizing the best AI models and the least human involvement depending on the complexity of the user question, instead of using any one of the three approaches for all types of questions.

Secondly, no other existing solution does the following. In one embodiment of the present invention, the system utilizes the last step in the cascade, whenever it is activated (it is only activated if the first two steps in the cascade fail), to retrain all other AI models in the cascading suite, not just the last one, to improve the output accuracy of all three models.

Hence the present invention is a closed loop cascading suite of AI models that delivers 100% accurate output for natural language questions against a database, with retraining of all upstream AI models based on human involvement in the last step of the cascade.

### SUMMARY

Deep Neural Networks (DNNs) in Natural Language Processing are a type of AI model that are capable of probabilistic pattern matching to see if a natural language utterance resembles a previously seen utterance they have been trained on, either exactly or similarly phrased, and produce an output or prediction based on this pattern match. This capability is used for a variety of uses such as sentiment analysis of sentences (the DNNs accept a natural language statement and output an indicator of sentiment such as negative, neutral or positive), or translation of a sentence into another language (I love you can be translated to Je t'aime in French), or in the case of the present invention translation of a natural language question into a database query. In one embodiment of the present invention the target database query is in the SQL language against a database that stores information and from which information can be retrieved, or into which records can be added or updated using the SQL language.

A database of information is based on a schema. A schema is a structure of tables that can store records. For example, in a customer table; the names of columns that represent the attributes of a record, or example the customer name, customer address, item purchased, date purchased etc. In addition, a database also has query logs which are previously executed queries that the database has responded to.

The present invention pertains to the observation that using a combination of the schema and the query logs it is possible to train a suite of DNNs to pattern match natural language questions to output to corresponding database queries with high accuracy.

The most accurate of these can identify and pattern match natural language questions, within a linguistically constrained set of natural language questions, with a high degree of accuracy and output database queries without user confirmation. The next most accurate can pattern match natural language questions, within a somewhat more linguistically flexible set of natural language questions, with a high degree of accuracy and output database queries that require user confirmation. And the least accurate of which can identify, and pattern match natural language questions, within a highly unconstrained set of natural language questions, but much less accuracy of the correctness of the output database query. However, in this final approach, with human involvement, the output database query can be leveraged and corrected into a very high accuracy query.

Training data for each of the three DNNs has the structure of a tuple: <natural language phrase, database query> so that each of the DNNs learns patterns of English sentences that correspond to queries and can learn to output a database query when it sees a new English phrase it has never seen before, based on its training.

The first, extremely accurate AI model that is trained is the QQP Model or (Question Question Pair). It is trained to detect very similar questions. The training data set for the QQP Model is based on the schema, from which a set of hypothetical database queries are produced. It is called the Bronze Data Set.

In one embodiment of the present invention these database queries are based on names of tables, names of columns in tables, and use a variety of database query language constructs from SQL, a popular database query language.

The full set of hypothetical queries is based on a permutation of tables and columns and SQL language clauses, and thus can be a very large set. Only a subset of them are then used along with constrained templates to auto-generate natural language phrases for each hypothetical query, to create the tuple needed in the training data set.

Since the phrases are auto-generated based on column labels in the database they are relatively simple and do not explore much linguistic flexibility. As an example, “Items purchased” might be an automatically generated phrase for a hypothetical database query that queries a database for a list of all items purchased. Only a limited subset of simple queries from the total Bronze Data Set of hypothetical queries generated are auto-labeled.

The second set of tightly coupled AI models that are trained, using a different training data set, are the IDSF & QVEnum models. The training data set for this AI model is not hypothetical. It is called the Gold Data Set.

The Gold Data set is based on query logs from prior actual database queries run on the target database. These actual database queries are discovered by the system and submitted for human labeling to build the <natural language phrase, database query> tuples for training.

Human labelers, who are capable of looking at the database query and skilled at understanding them enough to come up with the natural language phrase for each query, are asked to use a lot of linguistic flexibility for these queries. The human labelers create multiple natural language phrases for each query to truly offer a variety of ways of saying the same thing.

The queries in the Gold Data Set are analyzed and grouped to represent underlying a user intent across the group of queries. This set of intents becomes the Intent Data Set which is used to train the Intent Detection and Slot Filling (ISDF) model, and Query Values for Enumerated Types (QVEnum) model.

The third AI model trained is the NL2Query model, which is trained on a different subset of hypothetical queries generated based on the schema or the Bronze Data Set. Unlike the QQP model, complex queries are chosen and human labelers, who are expert in understanding the database query language, are asked to provide natural language phrases for each query. Since the queries are complex, the phrases are also likely to be complex.

In one embodiment of the present invention natural language questions are cascaded through three successive attempts by different DNNs, each of which is activated if the previous DNN is unable to predict an accurate output database query. The last DNN is able to make a prediction no matter what, although with the least probability of correctness accuracy since it is the most general of the three DNNs.

The first DNN component labelled QQP (Question Question Pairing) uses QQP Model that is able to fuzzy match with 100% accuracy against simple phrases such as “Get me list of customer names” or “Get me list of items purchased”. It is trained to look for close to exact match within fuzzy boundaries of questions it has been trained on and output the corresponding database query with no user involvement.

However, QQP may not be able to provide a 100% accurate output prediction of the database query needed, if a different natural language question is presented. For example, for a question like, “It was the first quarter I think, specifically Feb 20 to Feb. 29, 2020. How many items that cost more than $99.99 did customers purchase?” Such a question has much more linguistic flexibility and QQP is unlikely to have been trained on specifically this structure of a question, since the number of permutations in language are too many to cover in the relatively simple training set of QQP. QQP would report a failure condition to the system on complex types of questions such as this.

The system would then invoke the second DNN component (IDSF+QVEnum), which uses the Intent Detection and Slot Filling (IDSF) Model and the Query Values for Enumerated Types (QVEnum) Model.

In one embodiment of the present invention, the IDSF and QVEnum models are trained to deal with linguistic flexibility in a question and look for the “intent” and the “slots” inherent in a question, regardless of the exact way the question was asked.

Consider the following question: “How many items that cost more than $99.99 did customers purchase if I give you a date range like Feb 20 to Feb. 29, 2020. Can you answer that?”

The intent in this question is “Get me the number of items purchased” and the slots which will create filters in the database query are “Date Range”, “Greater than” “Price”.

A variety of intents and slots (thousands of intents, each with dozens of slots) can be detected by the IDSF Model with a very high accuracy and an output query can be generated for close to 100% accuracy of output, with a small amount of interaction with the end user. For the above question, user interaction could be a message such as “Detected Intent: Number of items purchased. Detected Slots: Date Range Feb. 20 2020, Feb. 29 2020. Item Price Condition: >$99.99. Is this correct? If yes, please confirm.” If the user confirms, the output predicted database query is generated and from the user's perspective it will generate 100% accurate results, because they had a chance to confirm exactly their intent and slots (or not: See below the third DNN component).

In one embodiment of the present invention, the QVEnum Model is used to map a phrase from the user's utterance to one of the enumerated values for a corresponding database column. For example, if the user asks “How many medium size shirts in the inventory?”, IDSF Model would identify “medium” as the value for the “size” slot. Now, say the “size” column is an enumerated column with values “S”, “M” and “L”. In this case, QVEnum Model would receive the column name “size”, the slot value “medium” and it would predict “M” as the column value that should be used to query the database. Again, the user is given a chance to confirm the slot value. These steps of user confirmation in IDSF and QVEnum are used to achieve very high accuracy.

If the user does not confirm the above interaction, the system is informed and in one embodiment of the invention, it once again cascades to the third DNN component which is the NL2Query component which uses the final and most general DNN model in the system the NL2Query Model.

The NL2Query Model has been trained on a training data set based on the target schema, to handle any question and output a predicted query no matter what the question, although its accuracy, since it is so general, on any one question hovers around 50% to 60%.

Tens of thousands or even hundreds of thousands of ways of asking questions can be used here. Given the lower expected accuracy of the NL2Query Model the system sends the NL2Query model's output to a business analyst who is capable of understanding the database query language only as a “recommended query.”

Since the end user does not know the database query language, a business analyst is required to review the recommended query, and who may accept the recommended query or correct or modify the query to make it 100% accurate.

In AI systems this is the traditional “human-in-the-loop” who deals with things when the AI model does not have confidence in its output. This final step of having a business analyst finalize the NL2Query output completes the cascade.

Once the business analyst has intervened, if needed, the system has performed its task of translating a natural language question to a database query using a suite of cascading DNNs, the first of which is the most constrained in its language understanding but highly accurate in its outputs with no end user involvement, the second of which is less constrained in its language understanding but highly accurate with some end user involvement, and the last of which is unconstrained in its language understanding but needs expert analyst involvement to approve its recommended output for it to deliver an accurate database query and corresponding result set.

Finally, in one embodiment of the invention, once the business analyst has been engaged to accept or improve or correct a recommended query, new information and thus new training data, including the analyst's contribution has become available to the system of the present invention for subsequent training of the system.

In one embodiment of the present invention, the business analyst is allowed to add the question and corresponding accepted, improved or corrected query to the training data set of one, two or all three of the DNN Models so they may perform better next time they see a similar question.

This closed loop feedback generates new training data from the NL2Query final, approved, or corrected query for appropriate QQP component.

If the natural language phrase corresponding to this query can be highly constrained it is used to train the IDSF+QVEnum component.

### BRIEF DESCRIPTION OF THE DRAWINGS

FIG. 1 is an overview block diagram of the major components and users of a computer-implemented client-server system and method that supports ad hoc Natural Language database questions that are transformed in realtime to SQL queries using a suite of Deep Neural Networks.

### DETAILED DESCRIPTION

Embodiments of the present invention provide a computer-implemented system that transforms ad hoc Natural Language database questions into appropriately formatted queries.

In one embodiment of the present invention, users submit ad hoc Natural Language database questions through a conversational user interface to a system that is initially and continually configured using database schema information and example question-query pairs. The system uses a suite of Deep Neural Networks to transform the question into a SQL query targeted at databases that are based on a SQL query interface. The query is then executed on a pre-configured database server and results are returned to the user.

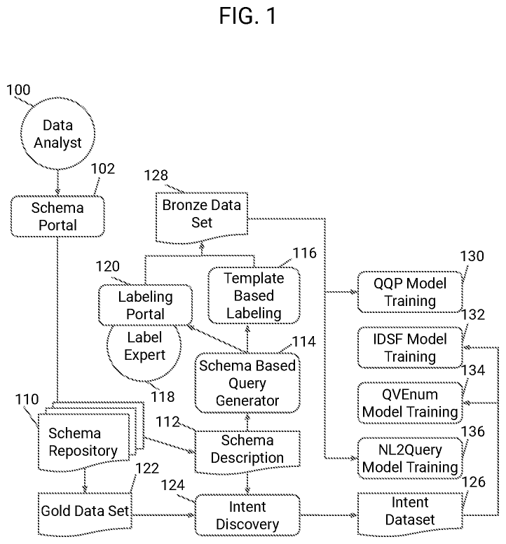

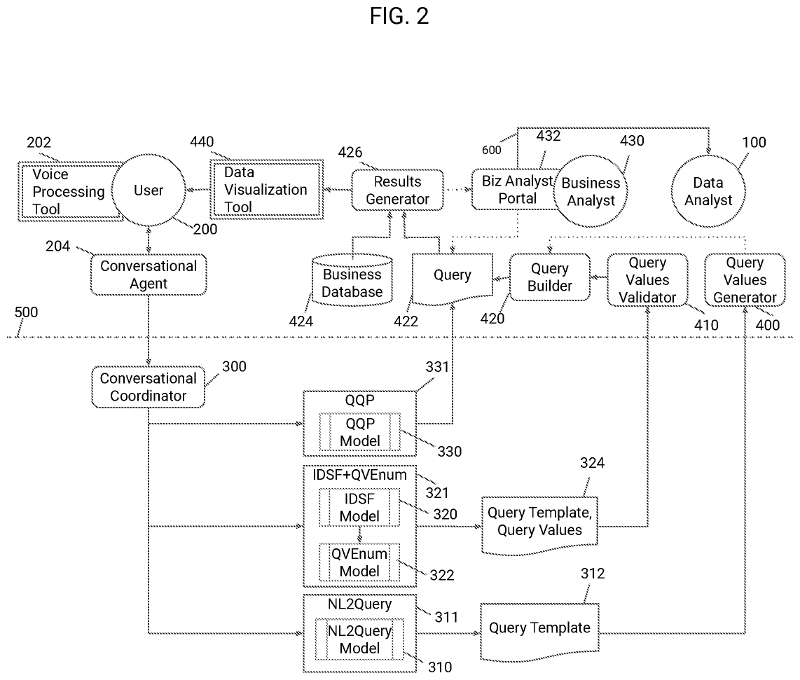

FIG. 1 is an overview block diagram of the major components and users of a computer-implemented client-server system and method that supports ad hoc Natural Language database questions that are transformed in realtime to SQL database queries using a suite of cascading Deep Neural Networks.

Referring to FIG. 1 and FIG. 2 those elements depicted within circles represent various users and administrators of the system that access the system via various client interfaces or devices including but not limited to voice recognition apps or devices, web browsers and mobile apps. All other elements depicted in the figure are the computer-implemented components of a client-server system according to one embodiment of the present invention.

The dotted horizontal line across FIG. 2 marks the Demarcation Zone (DMZ) 500 between the premises controlled by the business using the present invention, and the premises controlled by the operators of the present invention. All users, administrators and components above the Demarcation Zone (DMZ) 500 are under the control of the business entity using the present invention. And all users, administrators and components below the Demarcation Zone (DMZ) 500 are under the control of the operators of the present invention. All data that is private to the business using the present invention, exists only above the Demarcation Zone (DMZ) 500 and is never passed across the Demarcation Zone (DMZ) 500.

Now referring to FIG. 1, in one embodiment of the present invention the Data Analysts 100 are responsible for passing the training data to the suite of DNN components of the present invention. Training of the DNN components is done both initially before any user questions are submitted to the system and on a continual basis after the system is in operation. The training data provided by the Data Analysts 100 includes but is not limited to the Schema Description data 112 and the Gold Data Set 122. The Schema Description data 112 includes but is not limited to schema descriptions and Where value description data for each column of the Business Database 424. The Gold Data Set 122 includes but is not limited to frequently asked questions, their corresponding SQL queries and paraphrases of the frequently asked questions. Data Analysts 100 pass the Schema Description data 112 and the Gold Data Set 122 via the Schema Portal component 102 across the DMZ 500 to the components of the present invention in order to train the various DNNs.

Still referring to FIG. 1, in one embodiment of the present invention after the Schema Description data 112 is passed by the Schema Portal component 102 across the DMZ 500 it is first persisted in the Schema Repository 110. The Schema Description data 112 is then passed to the Schema Based Query Generator component 114 which creates a set of queries based on the Schema Description data 112.

Still referring to FIG. 1, the Schema Based Query Generator component 114, then takes the Schema Description data 112 and automatically generates a large number of hypothetical sample SQL queries. In one embodiment of the invention the number of sample SQL queries generated is in the range of thousands to ten of thousand sample queries. The distribution of SQL queries that are generated span the range of every possible query type including but not limited to queries with Joins, queries without Joins, queries with Order By, queries without Order By, queries with Aggregators, queries without Aggregators, queries with sub-queries, queries without sub-queries, etc.

Still referring to FIG. 1, in one embodiment of the present invention, the Template Based Labeling component 116 generates natural language utterances corresponding to a subset of the queries generated by Schema Based Query Generator component 114. A query along with its corresponding natural language utterance generated by the Schema Based Query Generator component 114 forms a tuple. The collection of these tuples is stored in the Bronze Data Set 128. These tuples are also referred to as the Auto Labeled Tuples.

Still referring to FIG. 1, in one embodiment of the invention, the remaining subset of queries generated by the Schema Based Query Generator component 114 are then passed to the Label Expert 118. The Label Expert 118 looks at each sample query and turns it into one or more natural language utterances using the Labeling Portal component 120. Each query and its corresponding natural language utterance form a tuple and the collection of these tuples are stored in the Bronze Data Set 128.

Still referring to FIG. 1, in one embodiment of the present invention, the Question Question Pairing (QQP) Model Training component 130 uses the Auto Labeled Tuples from the Bronze Data Set 128 to train a Question Question Pairing (QQP) Model 330 in FIG. 2. The QQP Model 330 in FIG. 2 is able to fuzzy match a given question with questions from the Bronze Data Set 128.

For example, if the Bronze Data Set 128 contains a question “Total sales for year 2019”, and the user asks the question, “Total sale for year 2019”. The QQP Model 330 in FIG. 2 matches the user question with Bronze Data Set 128 questions using fuzzy text matching. For instance, in this case, the words “sale” and “sales” produce the same result “sale” when stemmed. Thus, the QQP Model 330 in FIG. 2 would predict that the user question is close enough to Bronze Data Set 128 question “Total sales for year 2019”. When such a match is found, the corresponding Query 422 in FIG. 2 in the Bronze Data Set 128 is sent to the Results Generator Model component 426 in FIG. 2.

Now referring to FIG. 2, in one embodiment of the invention, the QQP Model 330 also attempts to match questions using exact match where each character in the questions matches.

Still referring to FIG. 2, in one embodiment of the invention, the QQP Model 330 also attempts to match questions using known synonyms.

Still referring to FIG. 2, in one embodiment of the invention, the QQP component 331 performs the necessary preprocessing steps on the input, uses the QQP Model 330 to generate a predicted output and then post-processes the output into the appropriate output format.

Still referring to FIG. 2, in one embodiment of the present invention the NL2Query Model component 310 is trained by the NL2Query Model Training component 136 of FIG. 1 using Schema Description data 112 of FIG. 1 and tuples of Natural Language Utterances and Query Templates 312. A Query Template 312 is a query with all values replaced by a placeholder. During inference, the model is presented with the Schema Description data 112 of FIG. 1 and a User's 200 utterance and it generates a Query Template 312. The Query Values Generator component 400 then finds out the values for each placeholder in the Query Template 312. A Query 412 is produced by taking the Query Template 312 and replacing placeholders with values generated by the Query Values Generator component 400.

Still referring to FIG. 2, in one embodiment of the invention, the NL2Query component 311 performs the necessary preprocessing steps on the input and uses the NL2Query Model 310 to generate a predicted output and then post-processes the output into the appropriate output format.

Now referring to FIG. 1, in one embodiment of the present invention, the Intent Discovery component 124 takes the Gold Data Set 122 and the Schema Description 112 and discovers user intents corresponding to each query in the Gold Data Set 122.

The Intent Discovery component 124 analyzes each query in the Gold Data Set 122 and splits each query into components such as WHERE conditions, tables and table joins used, SELECT columns and aggregations, etc. The components are then grouped as a set of intents that are stored in the Intent Data Set 126.

For example, consider the following example Gold Data Set utterance-query tuples:
“Which product is abcd sku?”—“SELECT name FROM products WHERE sku=‘abcd’”
“Give me product name for sku xyz.”—“SELECT name FROM products WHERE sku=‘xyz’”
“Total sales”—“SELECT sum(sales) FROM transactions”
   Here, the first two queries represent the same user intent, “get name of product for a given sku”. The third query represents a different intent “get total sales”. In this case, the Intent Discovery component 124 would produce an Intent Data Set 126 with two intents with following templates
Intent 0—“SELECT name from products sku=‘[query value]’”
Intent 1—“SELECT sum(sales) FROM transactions”

Still referring to FIG. 1, in one embodiment of the present invention, the IDSF Model Training component 132 takes the Intent Data Set 126, the Gold Data Set 122 and the Schema Description data 112 and trains models including but not limited to IDSF Model 320 in FIG. 2 to predict user intent and query values from an utterance from a User 200 in FIG. 2.

In the above examples, the IDSF Model 320 in FIG. 2 would be trained to predict Intent 0 for the first two utterances (“Which product is abcd sku?” and “Give me product name for sku xyz.”), and to predict Intent 1 for the last utterance “Total sales.” The IDSF Model 320 in FIG. 2 would also be trained to predict query values “abcd” and “xyz” for the first two utterances (“Which product is abcd sku?” and “Give me product name for sku xyz.”).

Similarly, the QVEnum Model Training component 134 takes the Intent Data Set 126, the Gold Data Set 122 and the Schema Description 112 and trains models including but not limited to the QVEnum Model 322 in FIG. 2. The QVEnum Model 322 in FIG. 2 is trained by using utterance values as input and corresponding enum column values as the target.

Now referring to FIG. 2, in one embodiment of the invention, the IDSF+QVEnum component 321 performs the necessary preprocessing steps on the input utterance. It then uses the IDSF Model 320 to predict Intent and Query Values for the utterance. The Query Values produced by the IDSF Model 320 are passed through the QVEnum Model 322 to produce corrected Query Values for any enumerated columns. The IDSF+QVEnum component 321 then looks up the Query Template corresponding to the Intent predicted by the IDSF Model 320 from the Intent Data Set 126. It then produces the Query Template 324 and the corrected Query Values 324 as output.

Each Deep Neural Network (DNN) component, including but not limited to the NL2Query DNN 311, the IDSF+QVEnum DNN 321 and the QQP DNN 331 are essentially pattern matching machines. (Note in FIG. 1 331, 321 and 311 should be labelled as DNNs)

After each of the Deep Neural Network (DNN) components have been trained the system is ready for user submitted natural language questions. When a user submits a natural language question to be converted into a SQL query and its associated where values, the Deep Neural Network (DNN) components look for similarities between the submitted question and the data it has been trained with in order to generate a corresponding query.

Still referring to FIG. 2, in one embodiment of the present invention, after the system has been trained, Users 200 can submit natural language questions to be processed by the system. Users 200 interact with various components and other users and administrators of the system including but not limited to the Data Visualization Tool component 440, the Voice Processing Tool components 202, the Conversational Agent component 204 and Business Analysts 430.

For example, a user might ask “How many buys greater than $100 did Leo Swanson make after Jan. 12, 2019.” The Conversational Agent component 204 removes any data that would be sensitive or private to the business and substitutes generic parameters to be passed over the DMZ 500.

The rules for which data is considered sensitive or private is configurable and is set by the Business. In this example the actual dollar value and the specific customer name would be masked. Resulting in a masked question of the form: “How many buys greater than $VALUE did $NAME make after Jan. 12, 2019.” At the same time the Conversational Agent component 204 persists the original sensitive data in a data store to be re-inserted later on in the process.

Still referring to FIG. 2, in one embodiment of the present invention, the Conversational Agent component 204 passes the natural language question with the masked parameters across the DMZ 500 to the Conversational Coordinator component 300.

Still referring to FIG. 2, in one embodiment of the present invention, the QQP component 331 is the first of the suite of the cascading Deep Neural Network Suite components. The Conversational Coordinator component 300 first queries the QQP component 331 to retrieve the Query 422 if a similar question already exists in the Bronze Data Set 128 in FIG. 1. In that case, the Query 422 is executed against the Business Database 424 by the Results Generator component 426 and the results are displayed to the User 200 using the Data Visualization Tool component 440.

Still referring to FIG. 2, in one embodiment of the present invention, if the QQP component 331 does not match the user question to a Bronze Data Set 128 question in FIG. 1, the Conversational Coordinator component 300 cascades to the second Deep Neural Network component which is the IDSF+QVEnum component 321, with the question, i.e. utterance.

Within the the IDSF+QVEnum component 321, the IDSF Model 320 predicts a known intent from the utterance and predicts query values as utterance phrases. The QVEnum Model 322 predicts any enumerated column values from the utterance phrases. The Query Template 324 corresponding to the predicted intent and the set of Query Values 324 are then sent to the Query Values Validator component 410 across the Demarcation Zone (DMZ) 500. The Query Values Validator component 410 checks Query Values 324 against corresponding column values in the Business Database 424 and generates a list of suggested values to be shown to the User 200 if a value in not found.

For instance, if Query Values 324 are {$BUYER NAME=“Leo Swanson”}, the Query Values Validator component 410 first looks if a “Leo Swanson” is in the Business Database 424. If instead of “Leo Swanson” the database returns a “Leonard Swanson”, the Query Values Validator substitutes “Leonard Swanson” for “Leo Swanson”. The Query Builder component 420 is then invoked to produce the Query 422 by combining the Query Template and validated, fixed query values. The Query 422 is executed against the Business Database 424 by the Results Generator 426 and the results are displayed to the User 200 using the Data Visualization Tool component 440.

Still referring to FIG. 2, in one embodiment of the present invention, if the QQP component 331 does not match the user question to a Bronze Data Set 128 question in FIG. 1, and the IDSF+QVEnum component 321 fails to predict a known intent, the Conversational Coordinator component 300 cascades next to the third Deep Neural Network component which is the NL2Query component 311 with the question, i.e. utterance.

The NL2Query component 311 uses the NL2Query Model 310 to generate a Query Template 312 that it expects to answer the user's question. The Query Values Generator component 400 predicts phrases from the utterance that can be used as Query Values. The Query Builder component 420 is then invoked to produce the Query 422 by combining the Query Template 312 and Query Values produced by the Query Values Generator component 420. The Query 422 is executed against the Business Database 424 by the Results Generator 426. However, the NL2Query Model 310 and the Query Values Generator component 420 are not reliable enough to show the results directly to the User 200. So, the question, the Query 422 and the results are sent to the Business Analyst Portal 432 instead. The Business Analyst 430 approves or rejects the question, inspects the query and results, and makes any necessary changes to the Query 422. The approved Query 422 is then sent to the Results Generator 426, where the Query 422 is executed against the Business Database 424 by the Results Generator 426 and the results are displayed to the User 200 using the Data Visualization Tool component 440.

Still referring to FIG. 2, in one embodiment of the present invention, Business Analysts 430 may interact with Users 200 to approve or deny a natural language question if the IDSF Model 320 indicates that the question does not map to a known intent. In such cases, Business Analysts 430 judge the semantic appropriateness of a question. For example, a Business Analyst 430 would deny a question like “Is there a god?” on the grounds that it knows that the Business Database 424 does not contain information to answer that question. In addition to interacting with Users 200, the Business Analysts 430 interacts with various components of the system including but not limited to the Business Analyst portal 432, the Business Database 424, and the Result Generator component 426.

Now referring to FIG. 1, in one embodiment of the present invention, user questions and corresponding Business Analyst 430 in FIG. 2 validated queries are logged and periodically sent to the Data Analyst 100. The Data Analyst 100 uses the Schema Portal 102 to add the question and query pairs to the Gold Data Set 122 and triggers the process of Intent Discovery 124 and model training 130, 132, 134 and 136. Once new models are trained and enabled for use, the system can answer questions similar to the newly added set of questions.

Still referring to FIG. 1, in one embodiment of the present invention, in case the schema for the Business Database 424 changes in FIG. 2, the Data Analyst 100 updates Schema Description 112 using the Schema Portal 102. Then Bronze Data Set 128 and Gold Data Set 122 are updated and DNN model training 126 invoked. Once new models are trained and enabled for use, the system can generate Queries 422 of FIG. 2 conforming to the updated schema for the Business Database 424 of FIG. 2.

The foregoing descriptions, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A system to facilitate online ad hoc multilingual natural language database questions that are transformed in realtime to database queries using a suite of cascading Deep Neural Networks which are initially and continuously trained through schema information and question-query examples, the system comprising:
a processor; and
a memory device coupled to the processor and storing executable program instructions therein, which, when executed by the processor, cause the system to perform operations comprising:
receiving over a network from a client device a client communication including an ad hoc multilingual natural language question of a database;
cascading the natural language query through at most three successive attempts by three different instances of Deep Neural Networks components in the system, each of which is activated if the previous Deep Neural Network component is unable to predict an output database query.

2. The system of claim 1, wherein the submitted natural language question is cascaded to the first instance of a Deep Neural Network component in the system, whose corresponding model is initially and continuously trained in auto label generated natural language questions and their corresponding queries based on the database schema. This first instance of a Deep Neural Network component in the system, using fuzzy logic, attempts to match the submitted natural language question against its model, and if successful returns the matching SQL query for execution.

3. The system of claim 1, wherein if a match is not successful using the method in claim 2, the system then cascades the submitted natural language question to the second instance of a Deep Neural Network component in the system, whose corresponding model is initially and continuously trained with previously submitted natural language questions and their corresponding queries, along with a set of inferred natural language questions based on previously submitted natural language questions. This second instance of a Deep Neural Network component in the system, attempts to resolve the linguistic ambiguity in the submitted natural language question using its model, and if successful returns the matching SQL query for execution.

4. The system of claim 1, wherein if a match is not successful using the method described in claim 3, the system then cascades the submitted natural language question to the third instance of a Deep Neural Network component in the system, whose corresponding model is initially and continuously trained with a vast range of hypothetical natural language questions and their corresponding queries based on the database schema. This third instance of a Deep Neural Network component in the system, attempts to match the submitted natural language question against its model and if successful returns an SQL query for execution.
